(19) United States
(12) Patent Application Publication
(10) Pub. No.: US 2001/0021743 A1
(43) Pub. Date: Sep. 13, 2001

(54) Method of producing a graft copolymer

(76) Inventors: Yuichiro Wakana, Kawasaki-shi (JP); Naruhiko Mashita, Yokohama-shi (JP); Yasuo Horikawa, Tokyo (JP); Tadashi Utunomiya, Kamakura-shi (JP); Tuyoshi Hamanaka, Yokohama-shi (JP)

Correspondence Address: SUGHRUE, MION, ZINN, MACPEAK & SEAS, PLLC, 2100 Pennsylvania Avenue, N. W., Washington, DC, 20037-3213, US

(21) Appl. No.: 09/749,753

(22) Filed: Dec. 28, 2000

(30) Foreign Application Priority Data
Dec. 28, 1999 (JP) 11-375188
Feb. 3, 2000 (JP) 2000-026648
Feb. 24, 2000 (JP) 2000-047026

(51) Int. Cl. C08K 5/01; C08G 69/08

(52) U.S. Cl. 524/474; 528/310

(57) ABSTRACT

A method of producing a high-performance graft copolymer having both low-creep characteristics and damping properties is disclosed, which comprises:

(I) an addition reaction step of obtaining an adduct (A) by reacting an ethylene-maleic anhydride copolymer (a1) having R¹ and R² as side chains with a primary amine (a2) at room temperature through stirring, wherein R¹ and R² may be the same or different, each representing a substituted or unsubstituted alkyl group having 1 to 20 carbon atoms;

(II) a ring-closing reaction step of obtaining an ethylene-alkylmaleimide copolymer (B) having R¹ and R² as side chains by dehydrating the adduct (A) through heating, wherein R¹ and R² have the same meanings as defined above;

(III) a kneading step of obtaining a blend (D) by kneading the copolymer (B) with a maleated polyalkylene (C) while heating; and

(IV) a grafting step of kneading the blend (D) and an alkylpolyamine (E) while heating to cause an addition reaction and a cross-linking reaction resulting from dehydration; wherein the steps (II)˜(IV) are carried out in a biaxial extruder. A low hardness polymer composition comprising the copolymer as a substrate, a process for producing the same, and a load-reducing damping material using the same are also disclosed. The polymer composition and particularly the load reducing damping material are useful as an insulator for, for example, CD-ROM, DVD, MD, and CD-R in audio relating equipment, information relating equipment, communication equipment, and the like.

### BACKGROUND OF THE INVENTION

1. Field of the Invention

The present invention relates to a method of producing a graft copolymer having both low-creep characteristics and damping properties, a low hardness polymer composition comprising the copolymer as a substrate, a process for producing the same, and a load-reducing damping material using the same. The polymer composition and particularly the load reducing damping material are useful as an insulator for, for example, CD-ROM, DVD, MD, and CD-R in audio relating equipment, information relating equipment, communication equipment, and the like.

2. Description of the Related Art

The polymerization of isobutylene and maleic anhydride by free radical initiation is well known in the prior art. Similarly, the copolymer of isobutylene and maleic anhydride is well known. Further, imidization between maleic anhydride and a primary amine group is a common, well-known chemical reaction. Various patent publications relating to such reaction are known, such as German Patent DE 4241538, Japanese Patent JP 94248017, Italian Patent EP 322905 A2, and the like. Others include L. E. Colleman, Jr., J. F. Bork, and H. Donn, Jr., J. Org. Chem., 24, 185(1959); A. Matsumoto, Y. Oki, and T. Otsu, Polymer J., 23 (3), 201(1991); L. Haeussler, U. Wienhold, V. Albricht, and S. Zschoche, Themochim. Acta, 277, 14(1966); W. Kim, and K. Seo, Macromol. Rapid Commun., 17, 835(1996); W. Lee, and G. Hwong, J. Appl. Polym. Sci., 59, 599(1996); and I. Vermeesch and G. Groeninckx, J. Appl. Polym. Sci., 53, 1356(1994).

The synthesis of monofinctional N-alkyl and N-aryl maleimides are also known in the art. They have been used to improve the heat stability of homo- and especially copolymers prepared from vinyl monomers. Typically, there are exemplified bulk resins such as ABS (acrylonitrile-butadiene-styrene ternary copolymer), a polyblend of acrylonitrile-butadiene copolymer and styrene-acrylonitrile copolymer, PVC (polyvinyl chloride), SAN (styrene-acrylonitrile copolymer), and PMMA (polymethyl methacrylate). Maleimide can be copolymerized with other monomers such as acrylonitrile, butadiene, styrene, methyl methacrylate, vinyl chloride, vinyl acetate, and many other comonomers. A more preferred practice in the industry is to copolymerize maleimide with other monomers such as styrene, and optionally with acrylonitrile, and then blend the resulting copolymer with ABS and SAN resins. In any case, the polymer compositions are suitably prepared so that their copolymers are fully compatible with bulk resins (e.g., ABS and/or SAN) as shown by the presence of a single glass transition point (Tg) as determined by differential scanning calorimetry (DSC). It has long been recognized that the blending of two or more polymers to form a wide variety of morphologies may provide products that potentially offer desirable combinations of characteristics.

As was described above, according to their characteristics, a variety of maleimide-modified polymers have been developed and suggested, and the blending of two or more polymers may provide a product which has the desired properties has also been recognized. Ilowever, with an increasing demand in recent years for materials having not only low-creep characteristics and damping properties but also a low hardness in the fields of, for example, audio equipment, information-related equipment, communication equipment, and home electronics equipment, there is a growing need for materials that show higher performance than conventional maleimide-modified polymers and polymer blends excellent in heat resistance. For example, polymer blends are in many cases thermodynamically immiscible, which leads to the problem that the desired dispersion cannot be obtained and therefore the resulting products will be weak and brittle in mechanical behavior. Anyway, so far it has been difficult to obtain polymer materials of high performance industrially.

Recently, with advances in and diversification of audio-related equipment, information-related equipment, communication equipment, and the like, the object of damping has also been diversified and ranges from the number of rotations of apparatuses to that of forced oscillations. Under the circumstances, insulators for CD-ROM, DVD, MD, CD-R, and the like have been required to be made of materials that have all the characteristics represented by (1) the capability of shifting the resonance frequency, (2) the capability of reducing the transmissibility of vibration, and (3) the load-deformation resistance.

However, there existed no material that has all the characteristics from (1) to (3) mentioned above, in other words, no material characterized by low hardness, high loss, and low-creep characteristics, since it has been difficult to reconcile high loss characteristics with low-creep characteristics. For example, if oil is added to a polymer material prepared utilizing glass transition in order to lower the hardness, high-loss performance cannot be obtained. Moreover, there are the problems that the use of an unvulcanized polymer leads to the development of fluidity and that the addition of a filler raises the hardness. In any case, it has been extremely difficult to satisfy all the characteristics from (1) to (3) mentioned above.

### SUMMARY OF THE INVENTION

Accordingly, it is an object of the present invention to provide a method of producing a high-performance graft copolymer having both low-creep characteristics and damping properties with which a polymer composition of low hardness can be realized, a polymer composition comprising the copolymer as its substrate, and a process for producing the same. It is another object of the present invention to provide a load-reducing damping material of low hardness, high loss performance, and low creep characteristics.

The inventors of the present invention made intensive and extensive studies to solve the above-mentioned problems and finally found that a polyalkylene-grafted (bi-substituted ethylene-alkylmaleimide copolymer) which is branched like legs of a centipede (hereinafter, referred to also as “centipede polymer”) has the above-mentioned characteristics. As a result of further investigation, the inventors also found that a gel composition comprising this centipede polymer as its substrate does posses high-loss and low-creep characteristics and is suitable as a load-reducing damping material. The present invention was accomplished based on the above findings.

That is, the present invention is a method of producing a graft copolymer, comprising:

(I) an addition reaction step of obtaining an adduct (A) by reacting an ethylene-maleic anhydride copolymer (a1) having R¹ and R² as side chains with a primary amine (a2) at room temperature through stirring, wherein R¹ and R² may be the same or different, each representing a substituted or unsubstituted alkyl group having 1 to 20 carbon atoms;

(II) a ring-closing reaction step of obtaining an ethylene-alkylmaleimide copolymer (B) having R¹ and R² as side chains by dehydrating the adduct (A) through heating, wherein R¹ and R² have the same meanings as defined above;

(III) a kneading step of obtaining a blend (D) by kneading the copolymer (B) and a maleated polyalkylene (C) while heating; and

(IV) a grafting step of kneading the blend (D) and an alkylpolyamine (E) while heating to cause an addition reaction and a cross-linking reaction resulting from dehydration;

in which the steps (II) through (IV) are carried out in a biaxial extruder.

Further, the present invention relates to a method of producing a graft copolymer gel composition which is characterized in that a polyalkylene-grafted (bi-substituted ethylene-alkylmaleimide copolymer) produced in accordance with the process described above is kneaded with an extender using a biaxial extruder.

Further, the present invention relates to a graft copolymer gel composition comprising: a polyalkylene-grafted (bi-substituted ethylene-alkylmaleimide copolymer) the main chain of which is an ethylene-alkylmaleimide copolymer having, as side chains, R¹ and R² that have the same meanings as defined above, and an extender, wherein its JIS A hardness is 0 to 40°, its compression set as measured under the conditions of 100° C. and 22 hours is 60% or less, and its loss factor (tan δ) as measured under the conditions of 20° C., a strain of 5%, and a frequency of 10 Hz is 0.3 to 0.8.

Furthermore, the present invention relates to a load-reducing damping material, comprising:

(I) a polyalkylene-grafted (bi-substituted ethylene-alkylmaleimide copolymer) constituted of a maleated crystalline polyalkylene grafted to, via an alkyl diamine, an ethylene-alkylmaleimide copolymer having, as side chains, R¹ and R² which have the same meanings as defined above formed by adding an alkyl amine having 4 to 18 carbon atoms to an ethylene-maleic anhydride copolymer having, as side chains, R¹ and R² which have the same meanings as defined above and causing a ring-closing reaction through dehydration by heating; and

(II) an oil.

### DESCRIPTION OF THE PREFERRED EMBODIMENTS

Hereinafter, the embodiments of the present invention will be specifically described.

In the process of the present invention, it is important that, firstly in the addition reaction step (I), a reaction between an ethylene-maleic anhydride copolymer (a1) having R¹ and R² as side chains (R¹ and R² are the same or different, each representing a substituted or unsubstituted alkyl group having 1 to 20 carbon atoms) and a primary amine (a2) is carried out while stirring under substantially dry conditions and at room temperature to give an adduct (A) according to the following formula. Preferably, the primary amine (a2) is used in an amount of 0.8 to 1.0 mol per 1 mol of the maleic anhydride unit of the copolymer (a1).

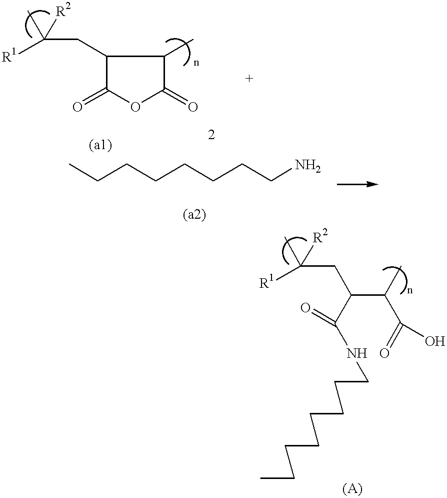

In the process of producing a load-reducing damping material, the copolymer(a1) is preferably isobutylene-maleic anhydride copolymer and the primary amine(a2) is preferably octyl amine.

This step can achieve an yield of 98% or higher in 24 hours even without heating. The reaction time is preferably 12 hours or longer. Further, for accelerating the reaction, it is preferred that the copolymer (a1) is provided in the form of a powder 90 to 100% of which is constituted of particles having a particle size of 200 μm or smaller. As the reactor, a ribbon mixer, a Henschell mixer, a V-type blender, or the like can be employed.

Since such addition reaction step (I) is carried out at room temperature, the amount of steam the primary amine (a2) evolves is small, and therefore, the handling becomes simple and safer. As the step comprises nothing but stirring, it is possible to effect the reaction with simple equipment. Furthermore, because heating is unnecessary in this step, the copolymer after the reaction shows almost no change in its form and remains powdery, which eliminates the need for pelletization thereof, consequently making the handling in the next step easier.

The mixing ratio is from 80 to 99mol %, preferably from 85 to 98mol % of the primary amine (a2) against 100mol % of the maleic anhydride (a1).

Copolymers (a1) that can be used in the present invention can be produced by a process well-known to those skilled in the art. The production of a copolymer which has R¹ and R² as side chains and is constituted of an electron-donating monomer such as ethylene and an electron-accepting monomer such as maleic anhydride, as a result of complexation of the electron-accepting monomer, can be carried out in the absence as well as in the presence of an organic free radical initiator in bulk, or in an inert hydrocarbon or halogenated hydrocarbon solvent such as benzene, toluene, hexane, carbon tetrachloride, chloroform, etc. (N. G. Gaylord and H. Antropiusova, Journal of Polymer Science, Part B, 7, 145 (1969) and Macromolecules, 2, 442 (1969); A. Takahashi and N. G. Gaylord, Journal of Macromolecular Science (Chemistry), A4, 127 (1970).

Copolymers (a1) that can be used in the present invention are each comprised of 5 to 99 mol %, preferably 20 to 50 mol %, most preferably 50 mol % of the maleic anhydride unit and the remainder being the ethylene unit having R¹ and R² as side chains. In such copolymers (a1), although their main chains may be of the random copolymerization type or the alternating copolymerization type, copolymers (a1) having a main chain of the alternating copolymerization type are preferable.

The weight average molecular weight of the copolymer (a1) is preferably about 1,000 to 500,000 or more, more preferably 10,000 to 500,000 or more, much more preferably 150,000 to 450,000.

R¹ and R² in the formula of the copolymer (a1) may be the same or different, examples of which are methyl, ethyl, propyl, isopropyl, butyl, isobutyl, pentyl, isopentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, cyclopropyl, 2,2-dimethylcyclopropyl, cyclopentyl, cyclohexyl, methoxymethyl, methoxyethyl, methoxypropyl, methoxybutyl, methoxypentyl, methoxyhexyl, methoxyheptyl, methoxyoctyl, methoxynonyl, methoxydecyl, ethoxymethyl, ethoxyethyl, ethoxypropyl, ethoxybutyl, ethoxypentyl, ethoxyhexyl, ethoxyheptyl, ethoxyoctyl, ethoxynonyl, ethoxydecyl, propoxymethyl, propoxyethyl, propoxypropyl, propoxybutyl, propoxypentyl, propoxyhexyl, propoxyheptyl, propoxyoctyl, propoxynonyl, propoxydecyl, butoxymethyl, butoxyethyl, butoxypropyl, butoxybutyl, butoxypentyl, butoxyhexyl, butoxyheptyl, butoxyoctyl, butoxynonyl, butoxydecyl, pentyloxymethyl, pentyloxyethyl, pentyloxypropyl, pentyloxybutyl, pentyloxypentyl, pentyloxyhexyl, pentyloxyoctyl, pentyloxynonyl, pentyloxydecyl, hexyloxymethyl, hexyloxyethyl, hexyloxypropyl, hexyloxybutyl, hexyloxypentyl, hexyloxyhexyl, hexyloxyheptyl, hexyloxyoctyl, hexyloxynonyl, hexyloxydecyl, heptyloxymethyl, heptyloxyethyl, heptyloxypropyl, heptyloxybutyl, heptyloxypentyl, heptyloxyhexyl, heptyloxyheptyl, heptyloxyoctyl, heptyloxynonyl, heptyloxydecyl, octyloxymethyl, octyloxyethyl, octyloxypropyl, octyloxybutyl, octyloxypentyl, octyloxyhexyl, octyloxyheptyl, octyloxynonyl, octyloxyoctyl, decyloxymethyl, decyloxyethyl, decyloxypropyl, decyloxybutyl, decyloxypentyl, decyloxyhexyl, decyloxyheptyl, 1-methylethyl, 1-methylpropyl, 1-methylbutyl, 1-methylpentyl, 1-methylhexyl, 1-methylheptyl, 1-methyloctyl, 1-methylnonyl, 1-methyldecyl, 2-methylpropyl, 2-methylbutyl, 2-methylpentyl, 2-methylhexyl, 2-methylheptyl, 2-methyloctyl, 2,3-dimethylbutyl, 2,3,3-trimethylbutyl, 3-methylpentyl, 2,3-dimethylpentyl, 2,4-dimethylpentyl, 2,3,3,4-tetramethylpentyl, 3-methylhexyl, 2,5-dimethylhexyl, and the like. The bi-substituted ethylene-maleic anhydride copolymer is preferably isobutylene-maleic anhydride copolymer, and powdered one is available from, for example, Kuraray Co., Ltd. under the name IM-10.

Moreover, examples of primary amines (a2) that can be employed in the present invention are alkyl amines, alkyl benzyl amines, alkyl phenyl amines, alkoxybenzyl amines, alkyl aminobenzoates, alkoxy anilines, and other linear primary amines, their alkyl or alkoxy substituents having from 1 to 50 carbon atoms, preferably from 6 to 30 carbon atoms. Although the alkyl and alkoxy substituents of such primary amines may be linear or branched, they are preferably linear. Although the substituents may be saturated or unsaturated, they are preferably saturated. Hexylamine, octylamine, dodecylamine, and the like are suitable.

In the case of providing a load-damping material, the alkylamine which is added to the above bi-substituted ethylene-maleic anhydride copolymer is preferably from 70 to 100 parts by weight per 100 parts by weight of the copolymer, and such alkylamine is preferably liquid octyl amine. The reason why the octyl amine is preferable is because an amine having shorter chain than the octyl amine makes difficult to show high loss characteristics and because an amine having longer chain than the octyl amine makes the cost higher although it shows high loss characteristics. While the octyl amine is liquid, the other amine can easily solidify, so that its handling becomes difficult. Moreover, the centipede polymer which is produced by the amine having so long chain is apt to crystallize, so that the polymer cannot show high loss characteristics. On the other hands, an alkyl amine having odd carbon number has a tendency to show high toxicity. The reason why the additional amount from 70 to 100 parts by weight per 100 parts by weight of the copolymer is preferable because the high loss characteristics can not be obtained if the amount is less than 70 parts by weight and because PP can not be provided so that a crystaline elastomer can not be obtained if the amount is more than 100 parts by weight, particularly with the use of the octyl amine.

Next, in the ring-closing reaction step (II), the adduct (A) obtained in the addition reaction step (I) is heated in a biaxial extruder and as a result dehydrated according to the following formula to give a copolymer (B) which has R¹ and R² as side chains (R¹ and R² have the same meanings as defined above) and is constituted of ethylene and an alkylmaleimide. In the step (II) for producing a load-reducing damping material, the copolymer (B) is preferably consisted of isobutylene and octyl maleimide.

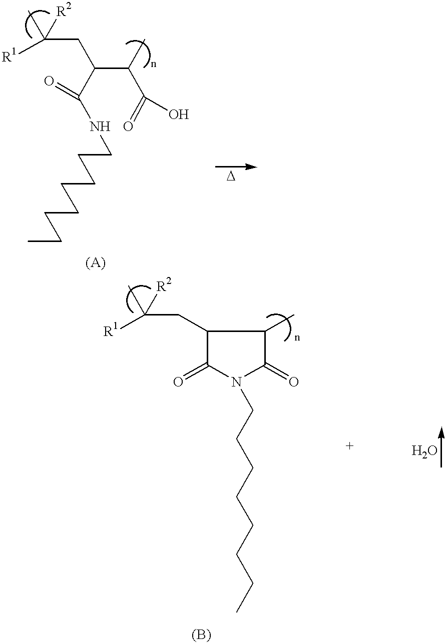

In the ring-closing reaction step (II), it is preferred that the ring-closing reaction in the biaxial extruder is carried out at a temperature not lower than 180° C. If the reaction temperature is 190° C., the reaction time is about 30 minutes. If the reaction temperature is 230° C., the reaction time is about 5 minutes. The rotation rate of the biaxial extruder is preferably from 50 to 400 rpm. Incidentally, including the following steps, the biaxial extruder does not need to be a specially improved one, and a conventional one can be employed.

In this step (II), a lot of H₂O is produced. It is preferred that the produced H₂O is forcedly eliminated from a given portion of the biaxial extruder with the use of a vacuum pump.

This can prevent the resulting strand from foaming in the presence of water vapor.

The copolymer (B) in the present invention is a so-called “centipede” polymer having a centipede-like structure, and has a high molecular weight and many relatively short side chains. The length of the main chain usually equals or is longer than the entanglement length (herein defined theoretically as an order of magnitude of 100 repeating units), while the length of the side chains is much shorter than the entanglement length. The structure of such copolymer (B) includes not only a random structure and a stereo-specific structure but a structure in which isobutylene and maleimide are alternately distributed. The weight average molecular weight is preferably from about 1,000 to 500,000 or more, more preferably from 10,000 to 500,000, much more preferably from 150,000 to 450,000.

Thereafter, in the kneading step (III), the copolymer (B) obtained in the ring-closing step (II) and a maleated polyalkylene (C) are kneaded in a biaxial extruder with heating to give a blend (D). In this step, no chemical reaction takes place and both materials are mixed together and dispersed well.

It is preferred that the kneading in the biaxial extruder in the kneading step (III) is conducted at a temperature not lower than 170° C. and that the kneading is carried out for as long a period of time as possible. For example, if the reaction temperature is 230° C., it is preferred that the kneading is conducted for 5 minutes or longer. The kneading zone is preferably set to not less than 10%, preferably not less than 20%, more preferably not less than 30% of the axis to disperse the material sufficiently.

In the case of providing a load-damping material, to the bi-substituted ethylene-alkylmaleimide copolymer obtained by the addition reaction of alkylamine and then the ring-closing reaction as a result of dehydration with heating is grafted preferably from 5 to 50 parts by weight of maleated crystalline polyalkylene via preferably form 0.1 to 10 parts by weight of alkyl diamine based on 100 parts by weight of the copolymer. If the polyalkyene is less than 5 parts by weight, the crystaline property can not be obtained, while if the polyalkylene is more than 50 parts by weight, the PP property is excess and the loss is low, the result of which the obtained material is too hard.

Maleated polyalkylenes (C) that can be employed in the present invention are conventionally known ones the alkylene-donating monomer of which is ethylene, propylene, or a copolymer thereof. Maleinization also can be effected according to any of the methods known to those skilled in the art. The weight average molecular weight of the polypropylene grafted segment is from about 10,000 to 10,000,000 or more, preferably from about 20,000 to about 300,000.

In the case of providing a load-damping material, the crystalline polypropylene copolymer maleated with maleic anhydride is preferable. Because the crystalline PP copolymer can increase heat-resistant to improve a setting at elevated temperature owing to its higher melting point. On the contraly, PE copolymer is not considered to show so good setting at 100° C. Moreover, in a process for blending with a base-polymer, the compatibility with it is needed, so that the other maleated copolymer than the crystalline PP copolymer can not be expected to be useful.

The crystallinity or stereoregularity of polypropylene ranges extremely widely from being substantially amorphous to being completely crystalline, that is, from 10 to 100%. Most typically, in anticipation of wide commercial use of isotactic polypropylene, the grafted polypropylene is substantially crystalline and its crystallinity or stereoregularity is, for example, about 90% or higher. Generally, polypropylene is substantially free from ethylene. However, a small amount of ethylene, on the order of less than about 5% by weight, may be incorporated thereinto. Furthermore, polypropylene may contain a small amount of ethylene in the copolymer known as “reactor copolymer”. Thus, the grafted polypropylene in the present invention is taken to contain both ethylene-propylene segments and polypropylene segments. Polymerization conditions for the preparation of polypropylene are well known, and polypropylene can be produced according to a conventionally known method.

The maleinization of polypropylene to maleated polypropylene can be carried out by the method well-known to those skilled in the art, and is conveniently accomplished by heating a blend of polypropylene and maleic acid at a temperature within the range of from about 150° C. to 400° C., under certain circumstances, in the presence of a free-radical initiator such as an organic peroxide known in the art. Such reaction is disclosed in the specifications of U.S. Pat. Nos. 3,480,580, 3,481,910, 3,577,365, 3,862,265, 4,506,056, and 3,414,551.

The maleated polyalkylene (C) to be used in the present invention contains, relative to its total weight, 0.01 to 5% by weight, preferably 0.01 to 2% by weight, more preferably 0.03 to 0.2% by weight of maleic anhydride.

Next, in the grafting step (IV), the blend (D) obtained in the kneading step (III) and an alkylpolyamine (E) are kneaded in the biaxial extruder while heating to cause, according to the following formula, an addition reaction and a cross-linking reaction resulting from dehydration. However, in the case of producing a load-reducing damping material, employed as the alkylpolyamine (E) is 1,10-diaminodecane.

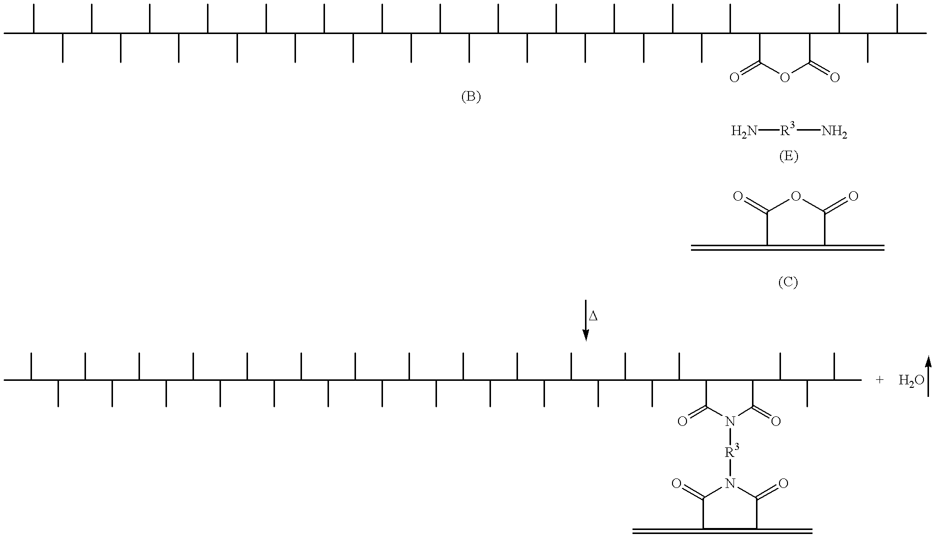

In the grafting step (IV), the grafting in the biaxial extruder is preferred carried out at a temperature of 180° C. or higher. If the reaction temperature is 190° C., the reaction time is about 18 minutes. If the reaction temperature is 230° C., the grafting is conducted for about 5 minutes. Moreover, the rotation rate of the biaxial extruder is preferably from 100 to 300 rpm.

The polyamine (E) that is used as a grafting agent (cross-linking agent) in the present invention is preferably a diamine, which grafts the maleated polyalkylene (C) onto the copolymer (B) by causing a cross-linking reaction therebetween. The grafting is carried out, under dry conditions, between approximately 50 to 99% by weight, preferably 70 to 99% by weight, particularly preferably 75 to 90% by weight of the copolymer (B), approximately 1 to 50% by weight, preferably 1 to 30% by weight, particularly preferably 8 to 25% by weight of the maleated polyalkylene (C) (preferably, polypropylene), and approximately 0.01 to 10% by weight of the alkylpolyamine (E) (preferably, diamine). Incidentally, the blending ratio should be suitably selected according to the characteristics required for the final composition.

Diamines or diamine mixtures that are suitably employed in the present invention are aliphatic or alicyclic compounds in which two primary amines are bound, which are represented by the formula R³(NH₂)₂ wherein R³ is an aliphatic hydrocarbon having from 1 to 20 carbon atoms, an alicyclic hydrocarbon having from 4 to 20 carbon atoms, an aromatic hydrocarbon having from 6 to 20 carbon atoms, or an N-heterocycle having from 4 to 20 carbon atoms.

Specific examples are ethylene diamine, 1,2- and 1,3-propylene diamine, 1,4-diaminobutane, 2,2-dimethyl-1,3-diaminopropane, 1,6-diaminohexane, 2,5-dimethyl-2,5-diaminohexane, 1,6-diamino-2,2,4-trimethyldiaminohexane, 1,8-diaminooctane, 1,10-diaminodecane, 1,1-diaminoundecane, 1,12-diaminododecane, 1-methyl-4-(aminoisopropyl)-cyclohexylamine, 3-aminomethyl-3,5,5-trimethyl-cyclohexylamine, 1,2-bis-(aminomethyl)-cyclobutane, 1,2-diamino-3,6- dimethylbenzene, 1,2- and 1,4-diaminocyclohexane, 1,2-, 1,4,1,5-, and 1,8-diaminodecalin, 1-methyl-4-aminoisopropyl-cyclohexylamine, 4,4′-diamino-dicyclohexyl, 4,4′-diamino-dicyclohexyl methane, 2,2′-(bis-4-amino-cyclohexyl)-propane, 3,3′-dimethyl-4,4′-diamino-dicyclohexyl methane, 1,2-bis-(4-aminocyclohexyl)-ethane, 3,3′,5,5′-tetramethyl-bis-(4-aminocyclohexyl)-methane and -propane, 1,4-bis-(2-aminoethyl)-benzene, benzidine, 4,4′-thiodianiline, 3,3′-dimethoxybenzidine, 2,4-diaminotoluene, diaminoditolylsulfone, 2,6-diaminopyridine, 4-methoxy-6-methyl-m-phenylenediamine, diaminodiphenyl ether, 4,4′-bis(o-toluidine), o-phenylenediamine, methylenebis(o-chloroaniline), bis(3,4-diaminophenyl)sulfone, diaminodiphenylsulfone, 4-chloro-o-phenylenediamine, m-amino-benzylamine, m-phenylenediamine, 4,4′-C₁˜C₆-dianilines such as 4,4′-methylenedianiline, aniline-formaldehyde resin, trimethylene glycol di-p-aminobenzoate, and mixtures of these diamines.

In the case of providing a load-damping material, the diamine is preferably 1,10-diamino decane. Because the primary amine in the centipede polymer is octyl amine, the use of a diamine having shorter carbon chain than the octyl amine makes difficult to effect the reaction owing to steric hindrance. The diamino decane is preferably used in an amount of from 0.1 to 10 parts by weight per 100 parts by weight of the copolymer. Because at least 0.1 part by weight of the diamine is necessary to bind the centipede polymer with PP, while if the amount is excess, the cost becomes higher.

Other suitable polyamines include bis-(aminoalkyl)-amines, preferably those having from 4 to 12 carbon atoms, for example, bis-(2-aminoethyl)-amine, bis-(3-aminopropyl)-amine, bis-(4-aminobutyl)-amine and bis-(6-aminohexyl)-amine, and isomeric mixtures of dipropylene triamine and dibutylene triamine. Hexamethylene diamine, and tetramethylene diamine are preferred, and especially 1,12-diaminododecane is preferred.

The desired polyalkylene-grafted (bi-substituted ethylene-alkylmaleimide copolymer), which can be applied preferably can be produced through the steps from (I) to (IV). Preferably, the kneading and the reactions in the biaxial extruder in the steps from (II) to (IV) are carried out continuously.

Next, in the method of producing a graft copolymer gel composition of the present invention, the polyalkylene-grafted (bi-substituted ethylene-alkylmaleimide copolymer) produced in such a manner as was described above is kneaded with an extender in the biaxial extruder.

The kneading with the extender is carried out after the completion of the grafting step (IV), but the extender may be added into a given portion of the biaxial extruder to thereby decrease number of kneading times in the biaxial extruder.

Preferably, the kneading in the biaxial extruder is conducted at a temperature of 100° C. or higher. If the kneading is carried out at 100° C., the kneading is conducted for about 3 minutes. The rotation rate of the biaxial extruder is preferably from 100 to 300 rpm. In the present invention, it is preferred that the kneading in the biaxial extruder and its preceding step of kneading and forming the polyalkylene-grafted (bi-substituted ethylene-alkylmaleimide copolymer) using the biaxial extruder are carried out continuously.

Extenders that can suitably be employed in the present invention include extender oils and low molecular weight compounds. Suitable extender oils include oils well known to those skilled in the art, such as silicone oils, aromatic oils, naphthenic oils, and paraffinic oils. Similarly, exemplified as oils that are suitable for use in the production of load-reducing damping materials are silicone oils, aromatic oils, naphthenic oils, and paraffinic oils. Of these, most preferred is di-tridecyl phthalate (DTDP). DTDP not only is well compatible with the centipede polymer and seeps little therefrom but improves the physical properties of the resulting damping material. In addition, it has the advantage of being relatively inexpensive.

Into the load-reducing damping material of the present invention is incorporated, per 100 parts by weight of the grafted copolymer, from 1 to 600 parts by weight, preferably from 50 to 500 parts by weight, more preferably from 80 to 300 parts by weight of oil. If no oil is added, the resulting resin will be hard and devoid of low-hardness, while the addition of too much oil lowers the strength. Examples of low molecular weight organic compounds useful as extenders that may contained in the gel composition of the present invention are low molecular weight organic materials having a number average molecular weight of less than 20,000, preferably less than 10,000, more preferably less than 5,000. Although there is no particular restriction as to the extenders, the followings are mentioned as concrete examples.

(1) Softening agents: aromatic, naphthenic, and paraffinic softening agents for rubbers and resins

(2) Plasticizers: plasticizers composed of esters of phthalic acid, mixed phthalic acids, aliphatic dibasic acids, glycol, fatty acids, phosphoric acid and stearic and; epoxy plasticizers; other plasticizers for plastics; and phthalate, adipate, sebacate, phosphate, polyether and polyester plasticizers for NBR

(3) Tackifiers: coumarone resins, coumarone-indene resins, terpene phenol resins, petroleum hydrocarbons, and resin derivatives

(4) Oligomers: crown ether, fluorine-containing oligomers, polybutenes, xylene resins, chlorinated rubber, polyethylene wax, petroleum resins, rosin ester rubber, polyalkylene glycol diacrylate, liquid rubber (e.g., polybutadiene, styrene/butadiene rubber, butadiene-acrylonitrile rubber, polychloroprene), silicone oligomers, and poly-α-olefins

(5) Lubricants: hydrocarbon lubricants such as paraffin and wax; fatty acid lubricants such as higher fatty acids and hydroxy-fatty acids, fatty acid amide lubricants such as fatty acid amides and alkylene-bis-fatty acid amides, ester lubricants such as fatty acid-lower alcohol esters, fatty acid-polyhydric alcohol esters, and fatty acid-polygylcol esters, alcohol lubricants such as fatty alcohols, polyhydric alcohols, polyglycol, and polyglycerol, metallic soaps, and mixed lubricants

(6) Petroleum hydrocarbons: synthetic terpene resins, aromatic hydrocarbon resins, aliphatic hydrocarbon resins, alicyclic hydrocarbon resins, aliphatic or alicyclic petroleum resins, alicyclic or aromatic petroleum resins, polymers of unsaturated hydrocarbons, and hydrogenated hydrocarbon resins

Other appropriate low-molecular weight organic materials include latex, emulsions, liquid crystals, bituminous compositions, and phosphazene. One or more of these materials may be used as extenders.

The gel composition according to the present invention comprises from 1 to 10,000, preferably from 30 to 1,000 parts by weight of an extender or extenders per 100 parts by weight of the graft copolymer. More preferably, the gel composition contains from 50 to 500 parts by weight, more preferably from 80 to 300 parts by weight of oil per 100 parts by weight of the graft copolymer. The weight ratio of the polyalkylene-grafted ethylene-alkylmaleimide copolymer to the extender(s) is preferably within the range of from 100:1 to 1:100, more preferably from 10:1 to 1:10.

It is desirable to add an additive well known in the rubber industry to the gel composition and the load-reducing damping materials according to the present invention suitably. Stabilizers, antioxidants, fillers, reinforcing materials, reinforcing resins, pigments, fragrances and the like are exemplified as such additives. Concrete examples of antioxidants and stabilizers are 2-(2′-hydroxy-5′-methylphenyl) benzotriazole, nickel dibutyldithiocarbamate, zinc dibutyl dithiocarbamate, tris(nonylphenyl) phosphate, and 2,6-di-t-butyl-4-methylphenol. Examples of fillers and pigments are silica, carbon black, titanium dioxide, and iron oxide. These components are suitably added to the gel composition according to the intended use of the product, and the amount of the additive or additives is preferably from 1 to 350 parts by weight per 100 parts by weight of the graft copolymer.

The reinforcing material which, when added to a resinous matrix, improves the strength of the polymer and gel composition may be inorganic or organic. Exemplified as the reinforcing material are glass fibers, asbestos, boron fibers, carbon and graphite fibers, whiskers, quartz and silica fibers, ceramic fibers, metal fibers, natural organic fibers, and synthetic organic fibers. Other elastomers and resins are also useful to enhance specific properties like damping properties, adhesion, and processability. Examples of other elastomers and resins that can be used in the present invention include REOSTOMER (produced by Riken Vinyl Industry Co., Ltd.), hydrogenated polystyrene-(medium or high 3,4) polyisoprene-polystyrene block copolymers such as HYBLER (produced by Kuraray Co., Ltd.), and polynorbomenes such as NORSOREX (produced by Nippon Zeon Co., Ltd.).

Such physical properties as shown below can be realized only with the graft copolymer gel composition or load-reducing damping materials of the present invention which has the above-described constitution. That is, its JIS A hardness as measured basically according to JIS K6301 is from 0 to 40°, preferably from 0 to 15°. If the hardness exceeds 40°, the gel composition of the present invention, when used as an insulator, cannot shift the resonance frequency sufficiently. Moreover, its compression set as measured under the conditions of 100° C. and 22 hours basically according to JIS K 6262 is 60% or less, preferably 50% or less. A compression set exceeding 60% leads to a failure in effectively inhibiting the gel composition or an insulator made therefrom from being deformed as a result of having been under load at high temperatures. Further, the loss factor (tan δ) as measured under the conditions of 20° C., a strain of 5%, and a frequency of 10 Hz is from 0.3 to 0.8, preferably from 0.4 to 0.8. If the value is smaller than 0.3, its effect of lowering the transmissibility of vibration becomes poor, while a loss factor exceeding 0.8 is unfavorable in terms of low-creep characteristics.

In the method of producing a load-damping material, for example, the kneading of the centipede polymer with the oil in the biaxial extruder is carried out.

The gel composition of the present invention produced in accordance with the above-described process is moldable with a conventional apparatus, and its molded article shows elastomeric characteristics and is very useful for applications that require high-temperature insulating properties and/or high damping properties. The gel composition of the present invention has excellent electrical properties as well.

As explained above, according to the present invention, it is possible to safety and simply produce a graft copolymer having both low-creep characteristics and damping properties and a low hardness polymer composition. Therefore, the polymer composition is useful as an insulator for, for example, CD-ROM, DVD, MD, and CD-R in audio relating equipment, information relating equipment, communication equipment, and the like.

### EXAMPLES

The following examples are given for the purpose of illustration of the present invention and are not intended as limitations thereof.

Addition reaction step (I)

At room temperature, 100 parts by weight of isobutylene-maleic anhydride copolymer (manufactured by Kuraray, Co., Ltd., ISOBAN 10, 95% of which is constituted of particles having a particle size of 200 μm or smaller) was reacted with 78 parts by weight of octylamine (manufactured by Kao Corp., FARMIN 08D) in a ribbon mixer for 0.3, 0.8, 1.5, 3.5, and 24 hours, producing an adduct (A) in an yield as shown in the following Table 1.

TABLE 1

| Time (h) | Yield (%) |
|---|---|
| 24 | 99.80 |
| 3.5 | 90 |
| 1.5 | 75 |
| 0.8 | 40 |
| 0.3 | 20 |

Ring-closing reaction step (II)

Using a biaxial extruder (type: manufactured by Toyo Seiki, Co., Ltd., LABO PLASTMILL 2D25S), the adduct (A) obtained in the above-described addition reaction step (I) in a 99.80 yield was subjected to dehydration under such conditions as shown in the following Table 2 to give isobutylene-octylmaleimide copolymer (B) in an yield as shown in the same table.

TABLE 2

| Temperature (° C.) | Residence time (minutes) | Yield (%) |
|---|---|---|
| 230 | 20 | 99.80 |
| 230 | 5 | 96.50 |
| 190 | 30 | 95 |

### Examples 1 to 8

To the copolymer (B) obtained in the ring-closing reaction step were added, per 100 parts by weight, 26.79 parts by weight of maleated polypropylene (PP-ma) (from Exxon Chemical Company, EXCElOR PO1050) in the kneading step (III), 1.13 parts by weight of diaminododecane (from Tokyo Kasei Kogyo Co., Ltd., 1,12-diaminododecane) in the grafting step (IV), and ditridecylphthalate (DTDP) (from Kao Corp., VINYCIZER 20). In the gel composition preparation step, the amount of DTDP was 66.43 parts by weight from Example 1 to 4, and that varied from Example 5 to 8. Thereafter, the gel composition thus obtained was subjected to biaxial extrusion under such conditions as shown in the following Table 3 and 4.

TABLE 3

| | Example | Example | Example | Example |
|---|---|---|---|---|
| | 1 | 2 | 3 | 4 |
| Biaxial | | | | |
| extruder | | | | |
| Type | Biaxial-1 | Biaxial-1 | Biaxial-1 | Biaxial-2 |
| Inside diameter D (cm) | 20 | 20 | 20 | 44 |
| Length/inside | 25 | 25 | 25 | 38.5 |
| diameter (L/D) | | | | |
| Kneading | 230 | 230 | 230 | 230 |
| temperature (° C.) | | | | |
| Rotation rate (rpm) | 120 | 120 | 120 | 200 |
| Residence | | | | |
| time (min.) | | | | |
| Ring-closing reaction | 20 | 5 | 5 | 6 |
| step (II) (dehydration) | | | | |
| Kneading step (III) | 20 | 3 | 10 | 6 |
| (PP-ma blend) | | | | |
| Grafting step (IV) | 10 | 3 | 10 | 6 |
| (diaminododecane | | | | |
| added) | | | | |
| Gel composition | 10 | 3 | 10 | 10 |
| preparation step | | | | |
| (DTDP added) | | | | |
| Physical | | | | |
| properties of | | | | |
| gel | | | | |
| composition | | | | |
| Compression set | 40 | 50 | 36 | 41 |
| (100° C., 22 h) *1 | | | | |
| tan δ *2 | 1.0 | 0.86 | 0.93 | 0.73 |
| (5% strain, 20° C., | | | | |
| 10 Hz) | | | | |
| JIS A hardness (°) | 37 | 27 | 37 | 47 |

TABLE 4

| | Example | Example | Example | Example |
|---|---|---|---|---|
| | 5 | 6 | 7 | 8 |
| Biaxial | | | | |
| extruder | | | | |
| Type | Biaxial-1 | Biaxial-1 | Biaxial-1 | Biaxial-1 |
| Inside diameter D (cm) | 20 | 20 | 20 | 20 |
| Length/inside | 25 | 25 | 25 | 25 |
| diameter (L/D) | | | | |
| Kneading | 230 | 230 | 230 | 230 |
| temperature (° C.) | | | | |
| Rotation rate (rpm) | 120 | 120 | 120 | 120 |
| Residence | | | | |
| time (min.) | | | | |
| Ring-closing reaction | 20 | 20 | 20 | 20 |
| step (II) (dehydration) | | | | |
| Kneading step (III) | 20 | 20 | 20 | 20 |
| (PP-ma blend) | | | | |
| Grafting step (IV) | 10 | 10 | 10 | 10 |
| (diaminododecane | | | | |
| added) | | | | |
| Gel composition | 10 | 10 | 10 | 10 |
| preparation step | | | | |
| (DTDP added) | | | | |
| Amount of DTDP | 33 | 50 | 60 | 70 |
| added (wt. %) | | | | |
| Physical | | | | |
| properties of | | | | |
| gel | | | | |
| composition | | | | |
| Compression set | 40 | 50 | 50 | 50 |
| (100° C., 22 h) *1 | | | | |
| tan δ *2 | 1.0 | 0.86 | 0.5 | 0.45 |
| (5% strain, 20° C., | | | | |
| 10 Hz) | | | | |
| JIS A hardness (°) | 30 | 20 | 14 | 0 |

*1: Compression set

Although the compression set was determined basically according to JIS K 6262, the sample size was changed to: height 6 mm, diameter 8 mm. Test time: 22 hours. Compressibility: 25%. Under such conditions, the compression set was calculated using the following formula.

Formula:

$$Cs = ( {t}_{0} - {t}_{2} ) / ( {t}_{0} - {T}_{1} ) \times 100$$

Cs: compression set (%)

t₀: original thickness of the test piece (mm)

t₁: thickness of the spacer (mm)

t₂: thickness of the test piece 30 minutes after having been taken off the compressor (mm)

*2: tan δ

The elasticity measuring apparatus, DYNAMIC ANALYZER RDA II manufactured by Rheometrics, Inc., was employed. The diameter and height of the sample were 8 mm and 6 mm, respectively. The measurement was made under the conditions of 20° C., a torsional shearing strain of 5%, and a frequency of 10 Hz.

What is claimed is:

1. A method of producing a graft copolymer, comprising:
(I) an addition reaction step of obtaining an adduct (A) by reacting an ethylene-maleic anhydride copolymer (a1) having R¹ and R² as side chains with a primary amine (a2) at room temperature through stirring, wherein R¹ and R² may be the same or different, each representing a substituted or unsubstituted alkyl group having 1 to 20 carbon atoms;
(II) a ring-closing reaction step of obtaining an ethylene-alkylmaleimide copolymer (B) having R¹ and R² as side chains by dehydrating the adduct (A) through heating, wherein R¹ and R² have the same meanings as defined above;
(III) a kneading step of obtaining a blend (D) by kneading the copolymer (B) with a maleated polyalkylene (C) while heating; and
(IV) a grafting step of kneading the blend (D) and an alkylpolyamine (E) while heating to cause an addition reaction and a cross-linking reaction resulting from dehydration;
wherein the steps (II)˜(IV) are carried out in a biaxial extruder.

2. The process according to claim 1, wherein the graft copolymer being a polyalkylene-grafted (bi-substituted ethylene-alkylmaleimide copolymer) comprises 50 to 99% by weight of the copolymer (B), 50 to 1% by weight of the maleated polyalkylene (C), and 0.1 to 10% by weight of the alkylpolyamine (E).

3. The process according to claim 1, wherein the copolymer (a1) is a powder 90 to 100% of which is constituted of particles having a particle size of 200 μm or smaller.

4. The process according to claim 1, wherein, in the biaxial extruder, the ring-closing reaction in the step (II), the kneading in the step (III), and the grafting in the step (IV) are carried out at 180° C. or higher, 140° C. or higher, and 180° C. or higher, respectively.

5. The process according to claim 1, wherein the kneading and reactions in the biaxial extruder in the steps from (II) to (IV) are carried out continuously.

6. The process according to claim 1, wherein R¹ and R² in an ethylene-maleic anhydride copolymer (a1) may be the same or different, and are groups selected from the group, consisting of methyl, ethyl, propyl, isopropyl, butyl, isobutyl, pentyl, isopentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, cyclopropyl, 2,2-dimethylcyclopropyl, cyclopentyl, cyclohexyl, methoxymethyl, methoxyethyl, methoxypropyl, methoxybutyl, methoxypentyl, methoxyhexyl, methoxyheptyl, methoxyoctyl, methoxynonyl, methoxydecyl, ethoxymethyl, ethoxyethyl, ethoxypropyl, ethoxybutyl, ethoxypentyl, ethoxyhexyl, ethoxyheptyl, ethoxyoctyl, ethoxynonyl, ethoxydecyl, propoxymethyl, propoxyethyl, propoxypropyl, propoxy butyl, prponentylyl, propoxyhexyl, propoxyheptyl, propoxyoctyl, propoxynonyl, propoxydecyl, butoxymethyl, butoxyethyl, butoxypropyl, butoxybutyl, butoxypentyl, butoxyhexyl, butoxyheptyl, butoxyoctyl, butoxynonyl, butoxydecyl, pentyloxymethyl, pentyloxyethyl, pentyloxypropyl, pentyloxybutyl, pentyloxypentyl, pentyloxyhexyl, pentyloxyoctyl, pentyloxynonyl, pentyloxydecyl, hexyloxymethyl, hexyloxyethyl, hexyloxypropyl, hexyloxybutyl, hexyloxypentyl, hexyloxyhexyl, hexyloxyheptyl, hexyloxyoctyl, hexyloxynonyl, hexyloxydecyl, heptyloxymethyl, heptyloxyethyl, heptyloxypropyl, heptyloxybutyl, heptyloxypentyl, heptyloxyhexyl, heptyloxyheptyl, heptyloxyoctyl, heptyloxynonyl, heptyloxydecyl, octyloxymethyl, octyloxyethyl, octyloxypropyl, octyloxybutyl, octyloxypentyl, octyloxyhexyl, octyloxyheptyl, octyloxynonyl, octyloxyoctyl, decyloxymethyl, decyloxyethyl, decyloxypropyl, decyloxybutyl, decyloxypentyl, decyloxyhexyl, decyloxyheptyl, 1-methylethyl, 1-methylpropyl, 1-methylbutyl, 1-methylpentyl, 1- methylhexyl, 1-methylheptyl, 1-methyloctyl, 1-methylnonyl, 1-methyldecyl, 2-methylpropyl, 2-methylbutyl, 2-methylpentyl, 2-methylhexyl, 2-methylheptyl, 2-methyloctyl, 2,3-dimethylbutyl, 2,3,3-trimethylbutyl, 3-methylpentyl, 2,3-dimethylpentyl, 2,4-dimethylpentyl, 2,3,3,4-tetramethylpentyl, 3-methylhexyl, 2,5-dimethylhexyl group.

7. The process according to claim 1, wherein the primary amine (a2) is one selected from the group consisting of alkyl amines, alkyl benzyl amines, alkyl phenyl amines, alkoxybenzyl amines, alkyl aminobenzoates, and alkoxy anilines, its alkyl or alkoxy substituent having from 1 to 50 carbon atoms.

8. The process according to claim 1, wherein an alkylene-donating monomer of the maleated polyalkylene (C) is ethylene, propylene, or a copolymer thereof.

9. The process according to claim 1, wherein the alkylpolyamine (E) is a diamine represented by the formula R³(NH₂)₂ wherein R³ is an aliphatic hydrocarbon having from 1 to 20 carbon atoms, an alicyclic hydrocarbon having from 4 to 20 carbon atoms, an aromatic hydrocarbon having from 6 to 20 carbon atoms, or an N-heterocycle having from 4 to 20 carbon atoms.

10. A method of producing a graft copolymer gel composition, wherein the polyalkylene-grafted (bi-substituted ethylene-alkylmaleimide copolymer) prepared according to the process recited in claim 1 is kneaded with an extender in a biaxial extruder.

11. The process according to claim 10, wherein the weight ratio of the polyalkylene-grafted (bi-substituted ethylene-alkylmaleimide copolymer) to the extender is within the range of from 100:1 to 1:100.

12. The process according to claim 10, wherein the kneading in the biaxial extruder is carried out at 100° C. or higher.

13. The process according to claim 10, wherein the kneading in the biaxial extruder and its preceding step of kneading and forming the polyalkylene-grafted (bi-substituted ethylene-alkylmaleimide copolymer) in the biaxial extruder are carried out continuously.

14. The process according to claim 10, wherein 1 to 350 parts by weight of an additive is added per 100 parts by weight of the polyalkylene-grafted (bi-substituted ethylene-alkylmaleimide copolymer) and the resulting mixture is kneaded with the extender in the biaxial extruder.

15. The process according to claim 10, wherein the extender is a softening agent, a plasticizer, a tackifier, an oligomer, a lubricant, a petroleum hydrocarbon, a silicone oil, an aromatic oil, a naphthenic oil, and/or a paraffinic oil.

16. A graft copolymer gel composition comprising: a polyalkylene-grafted (bi-substituted ethylene-alkylmaleimide copolymer) the main chain of which is an ethylene-alkylmaleimide copolymer having, as side chains, R¹ and R² which may be the same or different and are substituted or unsubstituted alkyl groups having 1 to 20 carbon atoms; and an extender, wherein its JIS A hardness is 0 to 40°, its compression set as measured under the conditions of 100° C. and 22 hours is 60% or less, and its loss factor (tan δ) as measured under the conditions of 20° C., a strain of 5%, and a frequency of 10 Hz is 0.3 to 0.8.

17. The graft copolymer gel composition according to claim 16, wherein a polyalkylene-grafted (bi-substituted ethylene-alkylmaleimide copolymer) comprises 50 to 99% by weight of the bi-substituted ethylene-alkylmaleimide copolymer, 50 to 1% by weight of the maleated polyalkylene, and 0.01 to 10% by weight of the alkylpolyamine.

18. The graft copolymer gel composition according to claim 16, wherein R¹ and R² in bi-substituted ethylene, may be the same or different, and are groups selected from the group, consisting of methyl, ethyl, propyl, isopropyl, butyl, isobutyl, pentyl, isopentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, cyclopropyl, 2,2-dimethylcyclopropyl, cyclopentyl, cyclohexyl, methoxymethyl, methoxyethyl, methoxypropyl, methoxybutyl, methoxypentyl, methoxyhexyl, methoxyheptyl, methoxyoctyl, methoxynonyl, methoxydecyl, ethoxymethyl, ethoxyethyl, ethoxypropyl, ethoxybutyl, ethoxypentyl, ethoxyhexyl, ethoxyheptyl, ethoxyoctyl, ethoxynonyl, ethoxydecyl, propoxymethyl, propoxyethyl, propoxypropyl, propoxybutyl, propoxypentyl, propoxyhexyl, propoxyheptyl, propoxyoctyl, propoxynonyl, propoxydecyl, butoxymethyl, butoxyethyl, butoxypropyl, butoxybutyl, butoxypentyl, butoxyhexyl, butoxyheptyl, butoxyoctyl, butoxynonyl, butoxydecyl, pentyloxymethyl, pentyloxyethyl, pentyloxypropyl, pentyloxybutyl, pentyloxypentyl, pentyloxyhexyl, pentyloxyoctyl, pentyloxynonyl, pentyloxydecyl, hexyloxymethyl, hexyloxyethyl, hexyloxypropyl, hexyloxybutyl, hexyloxypentyl, hexyloxyhexyl, hexyloxyheptyl, hexyloxyoctyl, hexyloxynonyl, hexyloxydecyl, heptyloxymethyl, heptyloxyethyl, heptyloxypropyl, heptyloxybutyl, heptyloxypentyl, heptyloxyhexyl, heptyloxyheptyl, heptyloxyoctyl, heptyloxynonyl, heptyloxydecyl, octyloxymethyl, octyloxyethyl, octyloxypropyl, octyloxybutyl, octyloxypentyl, octyloxyhexyl, octyloxyheptyl, octyloxynonyl, octyloxyoctyl, decyloxymethyl, decyloxyethyl, decyloxypropyl, decyloxybutyl, decyloxypentyl, decyloxyhexyl, decyloxyheptyl, 1-methylethyl, 1-methylpropyl, 1-methylbutyl, 1-methylpentyl, 1-methylhexyl, 1-methylheptyl, 1-methyloctyl, 1-methylnonyl, 1-methyldecyl, 2-methylpropyl, 2-methylbutyl, 2-methylpentyl, 2-methylhexyl, 2-methylheptyl, 2-methyloctyl, 2,3-dimethylbutyl, 2,3,3-trimethylbutyl, 3-methylpentyl, 2,3-dimethylpentyl, 2,4-dimethylpentyl, 2,3,3,4-tetramethylpentyl, 3-methylhexyl, 2,5-dimethylhexyl group.

19. The graft copolymer gel composition according to claim 16, wherein an alkylene-donating monomer of the polyalkylene in the polyalkylene grafted (bi-substituted ethylene-alkylmaleimide copolymer) is ethylene, propylene, or a copolymer thereof.

20. The graft copolymer gel composition according to claim 16, wherein the weight ratio of the polyalkylene-grafted (bi-substituted ethylene-alkylmaleimide copolymer) to the extender is within the range of from 100:1 to 1:100.

21. The graft copolymer gel composition according to claim 16, wherein 1 to 350 parts by weight of an additive is added per 100 parts by weight of the polyalkylene-grafted (bi-substituted ethylene-alkylmaleimide copolymer).

22. The graft copolymer gel composition according to claim 16, wherein the extender is a softening agent, a plasticizer, a tackifier, an oligomer, a lubricant, a petroleum hydrocarbon, a silicone oil, an aromatic oil, a naphthenic oil, and/or a paraffinic oil.

23. A load-reducing damping material, comprising:
(I) a polyalkylene-grafted (bi-substituted ethylene-alkylmaleimide copolymer) constituted of a maleated crystalline polyalkylene grafted to, via an alkyl diamine, an ethylene-alkylmaleimide copolymer having, as side chains, R¹ and R² which may be the same or different and are substituted or unsubstituted alkyl groups having from 1 to 20 carbon atoms formed by adding an alkyl amine having 4 to 18 carbon atoms to an ethylene-maleic anhydride copolymer having, as side chains, R¹ and R² which have the same meanings as defined above and causing a ring-closing reaction through dehydration by heating; and
(II) an oil.

24. The load-reducing damping material according to claim 23, wherein the ethylene-maleic anhydride copolymer is isobutylene-maleic anhydride copolymer in powder form.

25. The load-reducing damping material according to claim 23, wherein an alkyl amine is octyl amine.

26. The load-reducing damping material according to claim 23, wherein the alkyl diamine is 1,10-diaminodecane.

27. The load-reducing damping material according to claim 23, wherein the maleated crystalline polyalkylene is maleic anhydride-modified crystalline polypropylene.

28. The load-reducing damping material according to claim 23, wherein the oil is di-(tridecyl)phthalate.

29. The load-reducing damping material according to claim 23, wherein 70 to 100 parts by weight of the alkyl amine is added per 100 parts by weight of the ethylene-maleic anhydride copolymer.

30. The load-reducing damping material according to claim 23, wherein 5 to 50 parts by weight of the maleated crystalline polyalkylene is grafted to, per 100 parts by weight, the ethylene-alkylmaleimide copolymer via 0.1 to 10 parts by weight of the alkyl diamine.

31. The load-reducing damping material according to claim 23, wherein 1 to 600 parts by weight of the oil is added per 100 parts by weight of the ethylene-alkylmaleimide copolymer.

32. The load-reducing damping material according to claim 23, which has a JIS A hardness of 0 to 40°, a compression set as measured under the conditions of 100° C. and 22 hours of 60% or less, and a loss factor (tan δ) as measured under the conditions of 20° C., a strain of 5%, and 10 Hz of 0.3 to 0.8.

33. The load-reducing damping material according to claim 32, which has a JIS A hardness of 0 to 15°, a compression set as measured under the conditions of 100° C. and 22 hours of 50% or less, and a loss factor (tan d) as measured under the conditions of 20° C., a strain of 5%, and 10 Hz of 0.4 to 0.8.
